(19) United States
(12) Patent Application Publication
(10) Pub. No.: US 2019/0217694 A1
(43) Pub. Date: Jul. 18, 2019

(54) System and method of tailgate to truck bed sealing to prevent debris from falling into and lodging in a gap between a tailgate and a truck bed

(71) Applicant: Victor J. Battiato, West Chicago, IL (US)

(72) Inventor: Victor J. Battiato, West Chicago, IL (US)

(21) Appl. No.: 16/161,476

(22) Filed: Oct. 16, 2018

Related U.S. Application Data
(63) Continuation-in-part of application No. 15/598,276, filed on May 17, 2017, now Pat. No. 10,099,544.
Application No. 15/598,276 is a continuation-in-part of application No. 14/705,839, filed on May 6, 2015, now abandoned.
(60) Provisional application No. 61/992,898, filed on May 14, 2014.
(60) Provisional application No. 62/746,124, filed on Oct. 16, 2018.

(51) Int. Cl. B60J 10/84; B60R 13/06

(52) U.S. Cl. CPC B60J 10/84; B62D 33/027; B60R 13/06

(57) ABSTRACT

The tail gate seal or debris blocking device includes a flap, with adhesive backed fastening tape disposed on a bottom side tailgate end of the flap. The adhesive backed fastening tape couples the flap to the tail gate, and allows the tail gate to be removed by disengaging the two halves of the tape that are removabaly coupled together.

### CROSS-REFERENCE TO RELATED APPLICATION

This application also claims the benefit of U.S. Provisional Patent Application No. 62/746124, filed Oct. 16, 2018. This application is also a continuation in part of U.S. patent application Ser. No. 15/598,276 filed on May 17, 2017, now U.S. Pat. No. 10,099,544 which is a continuation in part of U.S. patent application Ser. No. 14/705,839 filed May 6, 2015 now abandoned, which in turn claims the benefit of U.S. Provisional Patent Application No. 61/992,898, filed May 14, 2014, the disclosure all of which are incorporated herein by reference.

### TECHNICAL FIELD

This description relates generally to sealing the bed of pickup trucks.

### BACKGROUND

The bed of pickup trucks is often lined with spray on coatings to protect the metal surface from scratches and to protect the cargo from damage. Additionally, some truck beds are covered with a flexible or ridged cap, or tonneau cover. This cap or cover also protects the cargo from environmental damage and theft.

Also in pickup trucks there is typically a tail gate that allows access to the truck box. The gate typically folds down and may be removable. When loose material like dirt, rocks and the like in a truck box are unloaded the gate is lowered and the materials are unloaded. There is typically a crack between the truck bed and the folded down tail gate. During unloading the rocks and material can fall in the crack where they are hard to remove and can jam the gate, as many people tend not to take the time to remove the gate before unloading. Also the material tend to fall through the crack and accumulate on the bumper or fall to the ground below where they make a mess that usually has to be swept, or shoveled up. Accordingly, it would be desirable to be able to prevent materials from entering the crack, and still allow tail gates to be easily removed.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified for as a prelude to the more detailed description that is presented later.

The tail gate seal or debris blocking device includes a flap, with adhesive backed fastening tape disposed on a bottom side tailgate end of the flap. The adhesive backed fastening tape couples the flap to the tail gate, and allows the tail gate to be removed by disengaging the two halves of the tape that are removabaly coupled together.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a thick tailgate seal with taper seal.

FIG. 2 shows a thin tailgate seal with taper seal.

FIG. 3 shows a pickup truck bed with the thick and thin seal applied.

FIG. 4 shows the thin seal applied at the truck bed floor.

FIG. 5 shows the thick seal applied at the sides of the truck bed.

FIG. 6 shows a flow diagram outlining the installation of the tailgate seals with taper seal.

FIG. 7 is a side cut away view showing debris blocking device installed on a pickup truck.

FIG. 8 shows the debris blocking device installed in a truck bed with the tail gate raised.

FIG. 9 shows the debris blocking device installed in a truck bed with the tail gate lowered.

FIG. 10 shows the debris blocking device installed in a truck bed with the tail gate lowered and the removable coupling to the tail gate.

FIG. 11 the debris blocking device installed in a truck bed with the tail gate lowered and with the blocking device disengaged from its mating tape strip prior to removing the tail gate.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a tailgate seal with taper seal. Although the present examples are described and illustrated herein as being implemented in a pickup truck bed, the system described is provided as an example and not a limitation. As those skilled in the art will appreciate, the present examples are suitable for application in a variety of different types of orifice sealing applications.

The tailgate seal with taper seal provides a seal that prevents the infiltration of dirt, rain, fumes, and the like from penetrating into a vehicle. The taper seal portion of the tailgate seal allows for use of one material where the gap to be sealed may be of a multitude of widths. Although dimensions are shown in some of the figures that follow, they are meant to be exemplary and are not intended to be a limitation.

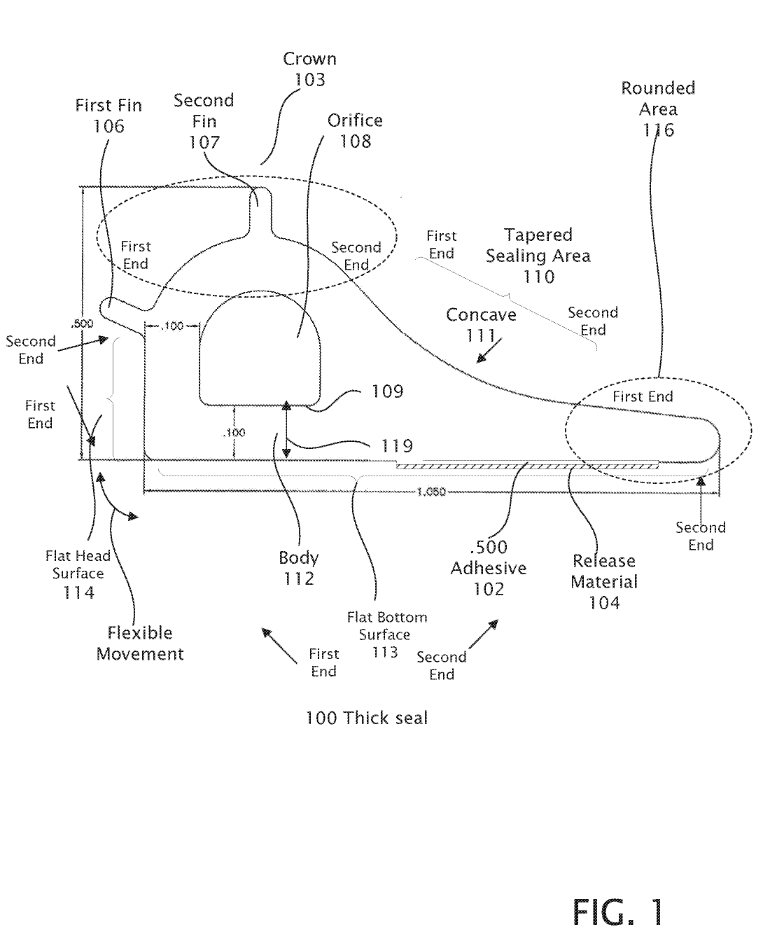

FIG. 1 shows a cross section of thick tailgate seal with taper seal 100. The tailgate seal is comprised of an elongate body 112 typically made from an elastomer such as silicone, EPDM (ethylene propylene diene monomer) rubber or the like. The seal is typically formed in a long piece with right angle extensions to fit the space between the sides of a tailgate and the longer bottom surface where the hinge may be located.

The body 112 has a tapered sealing area 110 that provides a reduced thickness for improved sealing of gaps of various widths, while allowing for easier closure of the tail gate due to removal of excess material which would cause resistance to closure of the gate. In particular the tapered sealing area has a concave, or dished out surface 111, that advantageously provides an improved seal while reducing the bulk of the seal over those that are not provided with such curvature. Previous seals may have attempted to ease closure by the use of additional voids in the tapered sealing area. However by providing a concave surface the need for such additional voids, that may be subject to breakthrough and rupture with extended use is removed.

The body 112 also has a hollow orifice 108, which allows compression and recovery of the tailgate seal. The orifice shown has a “D” shape, with the flat of the “D” substantially parallel to a flat bottom surface 113, and with the curved portion of the “D” generally matching the curvature of an exterior crown area 103.

The body includes a flat bottom surface 113 that fits against the truck frame. At a second end there is a rounded area 116 where the concave area of the tapered sealing area abuts the flat bottom surface. Because of the absence of voids this rounded area may be extended out providing more material to maintain the seal. The rounded area has a convex shape as it transitions from the tapered sealing area to the flat bottom surface.

At a first end of the flat bottom surface a first end of the flat head surface 114 is encountered. The flat head surface is generally perpendicular to the flat bottom surface, and extends to a second end of the flat head surface. At the second end of the flat head surface transitions to a first end of a crown area 103. At this juncture a first fin 106 is formed to aid in sealing the gate against the bed surface.

An adhesive strip 102, typically protected by a release material 104 is disposed adjacent to the second end of the flat bottom surface. The adhesive does not extend over the entire flat bottom surface because it has been found that by using substantially 50% coverage the first end of the flat bottom surface may flex during use, providing a better seal.

The crown area 103 is generally convex and includes a second fin 107 that is generally oriented vertically and is located at the peak of the crown. This second fin is substantially oriented at a right angle to the first fin so that seals against two different surfaces (not in the same plane) in the jamb of the tail gate and bed are sealed. It is worth pointing out that the first and second fins seal different areas of the truck body, which is why they are spaced at substantially right angles from each other, and which is why they are not closely spaced together as if they were constructed to seal against a single planar surface.

A second end of the crown area 103 transitions from a convex curve to a concave curve at a first end of the tapered sealing area 110. A second end of the tapered sealing area transitions to the convex curvature encountered at a first end of the rounded area 116, and finally a second end of the rounded area transitions into the second end of the flat bottom surface 113.

Fins 106, 107 are provided to aid the seal gaps between a tailgate and a truck bed differing surfaces (at differing angles). In one example, the seal body 112 has a flat bottom body surface 113 and a flat head surface 114 generally perpendicular to the flat bottom surface 113. The orifice 108 has a flat bottom orifice surface 109 parallel to the surface 113 with a distance 119 between the flat bottom orifice surface 109 and the flat bottom body surface 113. The tapered sealing area 110 comprises a tail section, or rounded area, 116 with a thickness less than the distance 119. In another example, the seal body 112 further includes a plurality of fins 106 extending from the flat head surface 114 and extending upward from the orifice area respectively.

The tailgate seal is provided with a self-adhesive layer 102 on the flat bottom body surface 113 which maintains the tailgate seal in opposition to the truck body. To protect the adhesive, it is covered with a release material 104 which is removed for installation of the tailgate seal. The self-adhesive layer 102 may have various widths. In one example, the self-adhesive layer 102 is only provided within the tapered sealing area 110 for the thick tailgate seal, which allows flexible movement of the tailgate seal around the orifice 108.

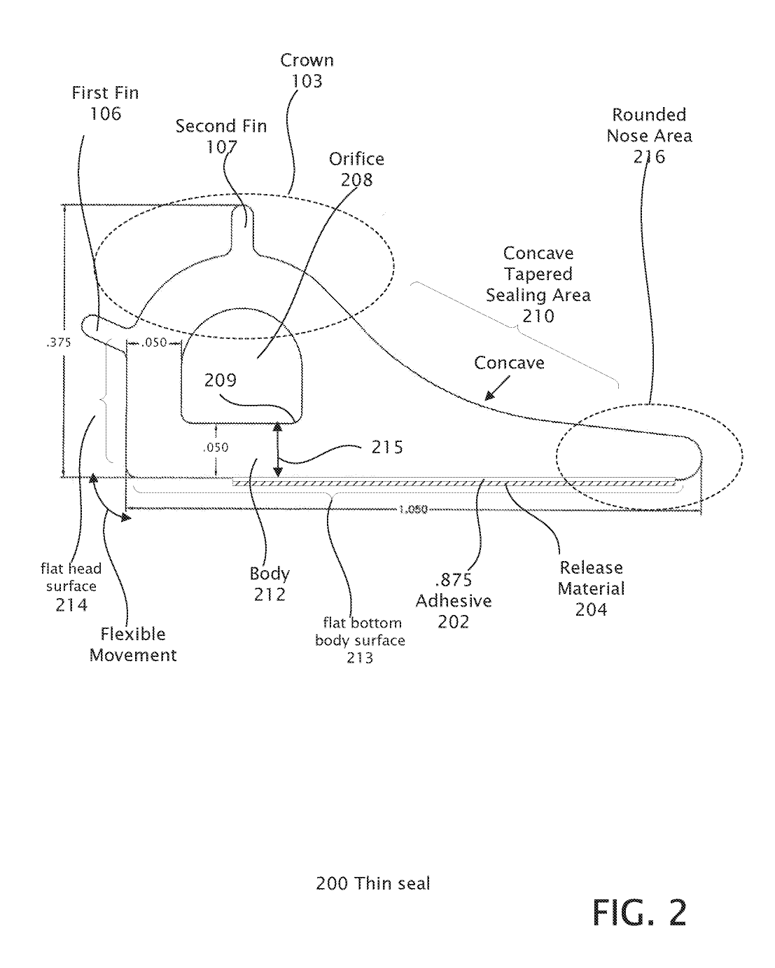

FIG. 2 shows a cross section of thin tailgate seal with taper seal 200. It is proportioned as described in FIG. 1. The tailgate seal in this figure provides similar attributes as that shown in FIG. 1, but is provided with different dimensions. This thinner tailgate seal 200 is provided with a tapered sealing area 210, an orifice 208, fins 206, a self-adhesive layer 202 covered with a release material 204. Although dimensions are shown in FIG. 1 and FIG. 2, these are meant to be exemplary and not limiting. Those skilled in the art will recognize that the present examples are suitable for application in a variety of different types of orifice or opening sealing applications. The aforementioned mention structure in FIG. 1 may also be applicable to FIG. 2. For example, the seal body 212 has a flat bottom body surface 213 and a flat head surface 214 perpendicular to the flat bottom surface 213. The orifice 208 has a flat bottom orifice surface 209 parallel to the surface 213 with a distance 215 between the flat bottom orifice surface 209 and the flat bottom body surface 213. The tapered sealing area 210 comprises a tail section 216 with a thickness less than the distance 215. In another embodiment, the seal body 212 further comprises a plurality of fins 206 extending from the flat head surface 214 and extending upward from the orifice area respectively. The self-adhesive layer 202 may have various widths. In one embodiment, the self-adhesive layer 202 extends beyond the tapered sealing area 210 to cover at least some of the flat bottom body surface 213 in proximity of the orifice 208.

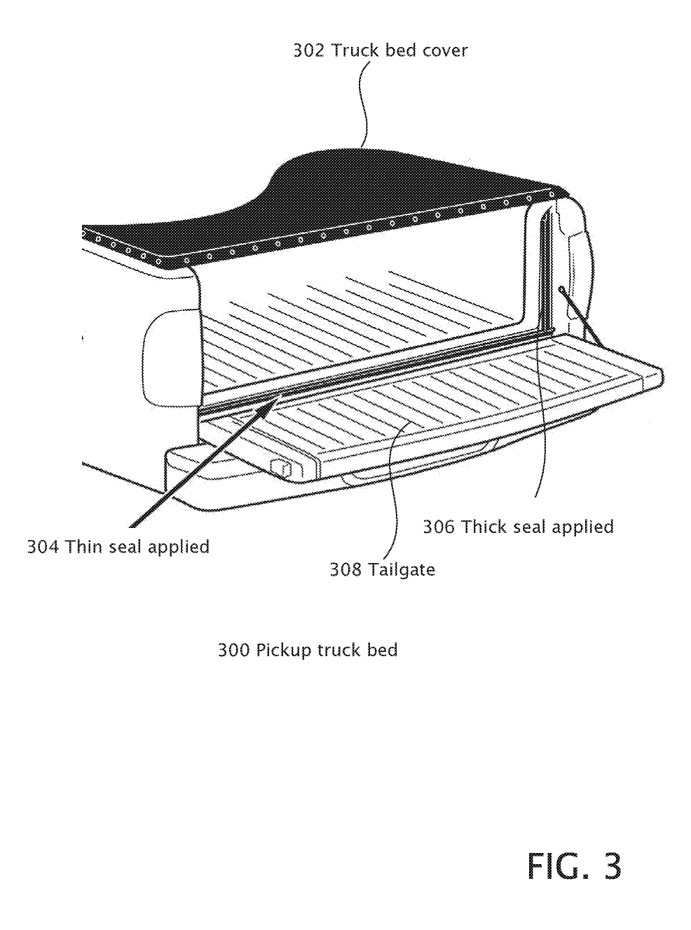

FIG. 3 shows a pickup truck bed with the seal applied. The tailgate seal 304 and 306 is applied to the three sides of the pickup truck bed where the tailgate 308 meets the truck bed. When the tailgate 308 is closed, the tailgate seal 304 and 306 seal any gap between the tailgate 308 and truck bed. In one embodiment, the tailgate seal 304 and 306 have the same dimension. In another embodiment, the tailgate seal 304 and 306 have different dimensions.

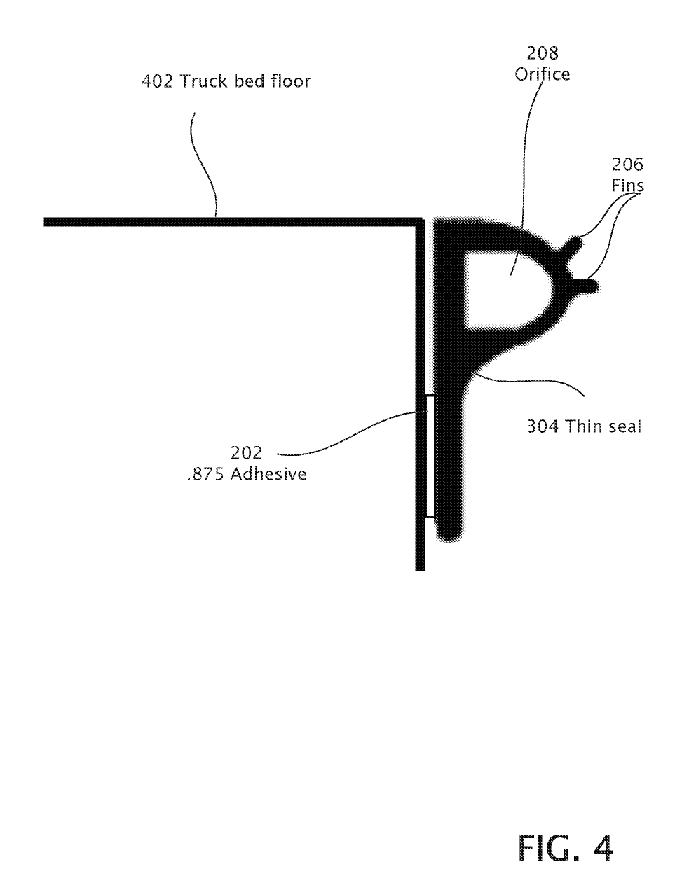

FIG. 4 shows the thin seal applied at the truck bed floor. The tailgate seal 304 is applied at the edge of the truck bed floor with the edge of the tailgate seal with the orifice 208 and fins 206 closest to the truck bed floor. In one embodiment, the flat head surface 214 is flush with truck bed floor surface 402 for a flat surface. Although the thin seal applied at the truck bed floor as shown I FIG. 4, it is understood that the thick seal may also be applied at the truck bed floor.

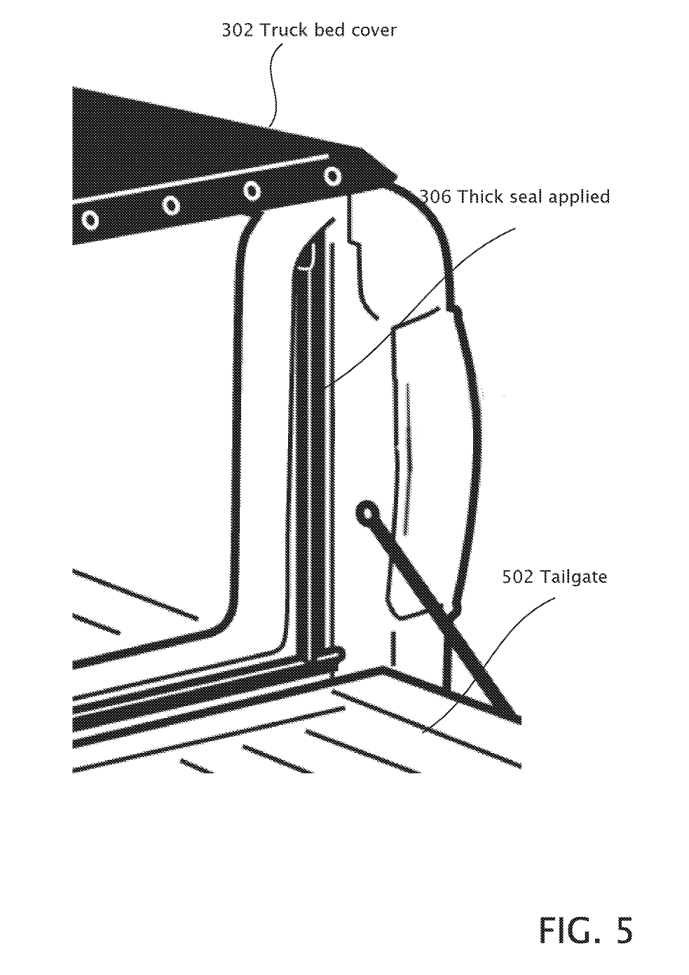

FIG. 5 shows the thick seal 306 applied at the sides of the truck bed. The application is similar to that shown in FIG. 4 in that the orifice and fins (not shown) are placed closest to the truck bed opening.

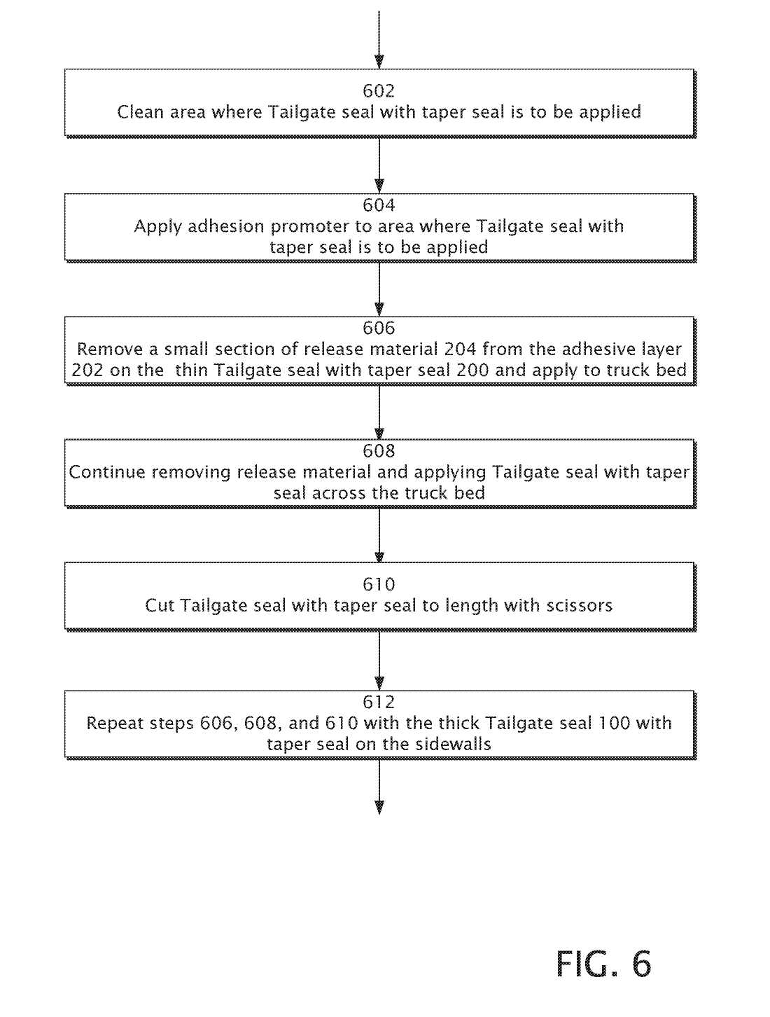

FIG. 6 shows a flow diagram outlining the installation of the tailgate seals with taper seal. At block 602, the area where the tailgate seal with taper seal 100 and 200 are to be applied is cleaned with soap and water and dried. Once dry, the areas are cleaned with isopropyl alcohol and allowed to dry. At block 604, an adhesion promoter may optionally be applied to the areas where the tailgate seal with taper seal is applied. An adhesion promoter is typically not needed for a painted surface, but may help when installing a tailgate seal to a spray liner. At block 606, a small portion of the release material 204 is removed from the adhesive 202 and the tailgate seal applied to the truck bed starting at one end. At block 608, the process of removing a small section of release material from the adhesive layer is continued across the floor of the truck bed. At block 610, the tailgate seal is cut with scissors.

At block 612, the tailgate seal 100 is applied to the sides of the tailgate opening, beginning at the bottom of the opening, progressing up the side wall to the top of the opening, then cutting the tailgate seal with scissors to fit. This block is repeated on the opposite side of the tailgate opening.

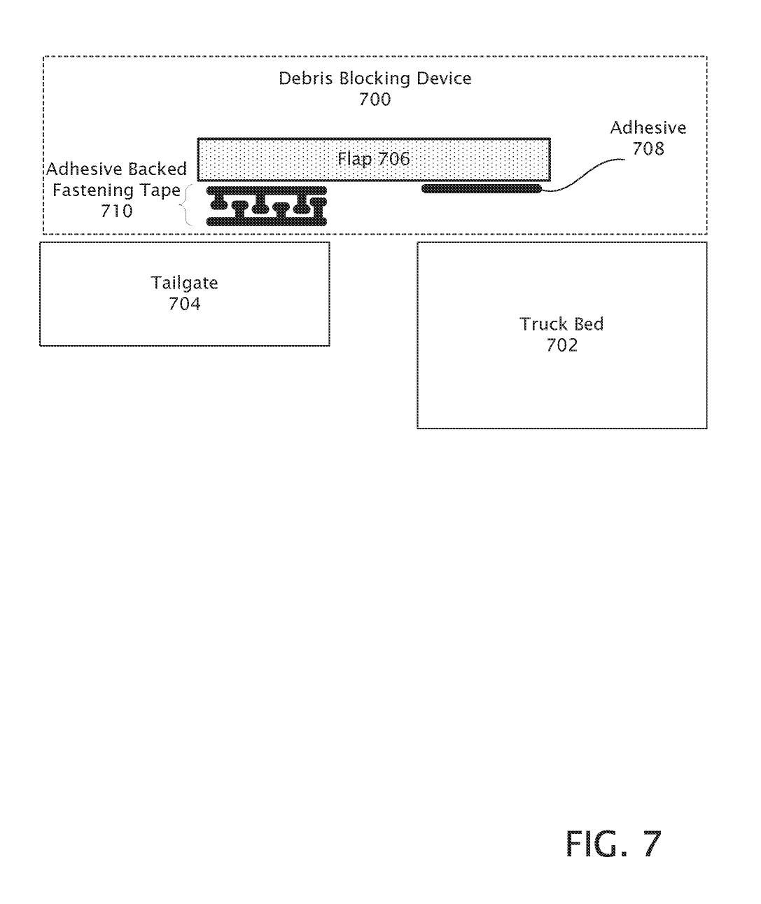

FIG. 7 is a side cut away view showing debris blocking device installed on a pickup truck. The tail gate seal or debris blocking device 700 includes a flap 706, with adhesive backed fastening tape 710 disposed on a bottom side tailgate end of the flap 706. And adhesive disposed on a bottom side bed end of the flap 706.

The tail gate seal or debris blocking device 700 includes a flap 706, with adhesive backed fastening tape 710 disposed on a bottom side tailgate end of the flap 706. The adhesive backed fastening tape 710 couples the flap to the tail gate 704, and allows the tail gate 704 to be removed by disengaging the two halves of the tape 710 that are removabaly coupled together. Alternatively fastening tape may be supplied as a separate piece for attachment to the tail gate and the flap 706 in the field.

At a bed end of the flap 706, on the bottom side adhesive attaches the flap to the truck bed. Typically adhesive is provided pre disposed upon the flap, and has peel away release paper or material covering the adhesive. Alternatively double sided tape may be used to attach the flap 706 to the bed 702.

The tail gate seal or debris blocking device 700 is typically 62×4.2×0.1 inches, 62×7.0×0.1 inches, or equivalent in overall dimensions. It may be supplied in a roll of any convenient length. The blocking device may be used in conjunction with a tail gate seal to prevent the intrusion of moisture , dirt and the like in the bed area, in particular when a shell, tonneau cover or the like is used to cover the truck bed. In particular the blocking device may be used to seal the bed to the gate, and the tail gate seal used to seal the box sides to the tailgate. Optionally the horizontal portion of the tailgate seal between the tailgate and the truck bed may be installed if desired. A suitable tail gate seal is described in TAILGATE SEAL FOR A PICKUP WITH A TRUCK CAP OR COVER, U.S. Pat. No. 10,099,544 issued Oct. 16, 2018, the contents of which are hereby incorporated by reference.

The flap 706 is made from flexible and resilient material to allow it to flex when the tail gate is raised. Rubber or the like may be used for the flap. The flap is of sufficient thickness to withstand use, typically a uniform thickness of approximately 0.1 inches for a rubber flap. Also the flap is typically flexible enough to conform to ridges and irregularities in the truck bed and gate so that gaps are not present in which debris might accumulate, or escape. Although shown as rectangular other shapes are contemplates such as those having a one or more tapered edges, longitudinal ridges, thicker in one area, or let out in a given area to accommodate flexing, or the like.

The adhesives 708 used to adhere the flap to the bed and the removable tape strips to the flap and the tail gate typically adheres to metal and surface finishes (paint), including spray on bed liners, using integrated 3M brand ST1200 tape, or the like. Use of an activator or a primer to aid in adhesion may be desired.

The adhesive backed fastening tape 710 includes two removabally engages strips that are removabally coupled together with mushroom posts, hook and loop, snaps, or the like. One strip attaches to the flap 706, and the other mating strip that attaches to the tailgate may be provides with a release strip or paper. VELCRO™ Brand ALFA-LOK™ removable tape is used in an example of the invention. It functions like hook and loop tape but tends to be more rugged and waterproof, tending not to lose holding strength when wet. Unlike hook and loop tape this tape utilizes base with flexible vertical posts protruding from the base. Each post has a protruding or nail shaped head. When mating strips are pressed together the nail heads interlock to keep the two pieces joined together.

Accordingly when it is desired to remove the tailgate the flap end with the adhesive backed fastening tape is pulled away so the tail gate can be removed. When the tail gate is replaced the flap is folded back over the tailgate and the two tape pieces pressed together so that the nail heads catch on each other to couple the flap 706 to the tailgate 704 via the adhesive tape.

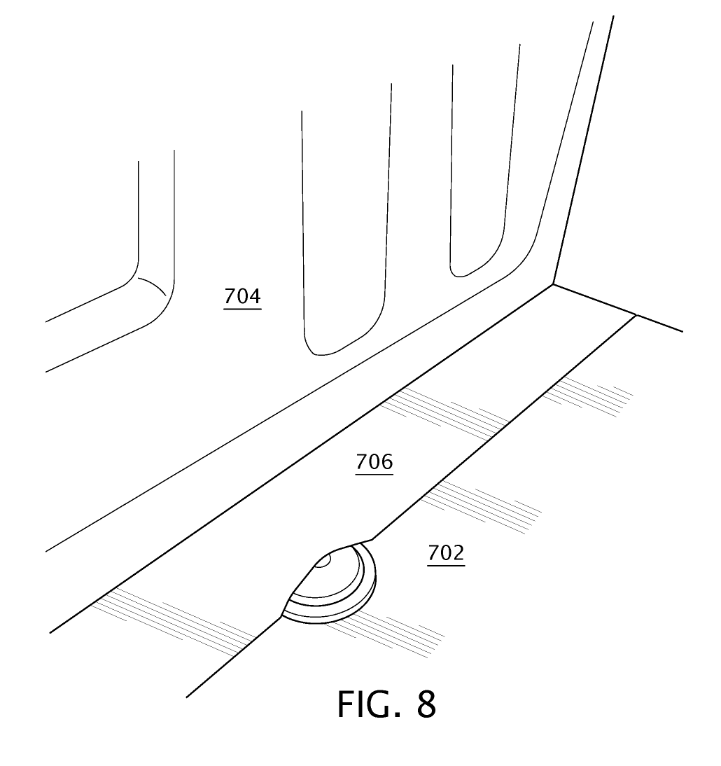

FIG. 8 shows the debris blocking device installed in a truck bed with the tail gate raised.

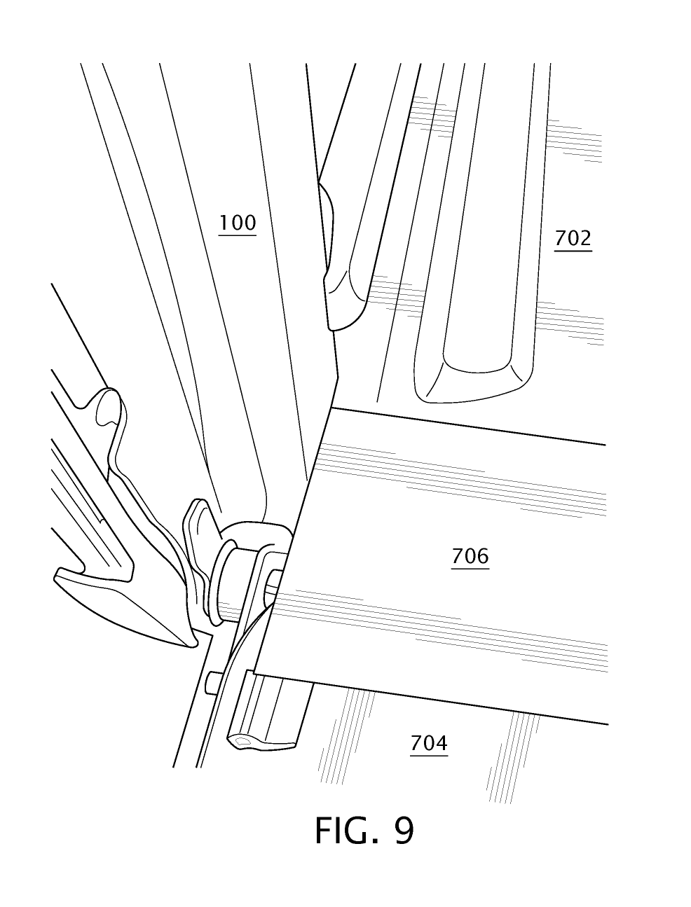

FIG. 9 shows the debris blocking device installed in a truck bed with the tail gate lowered.

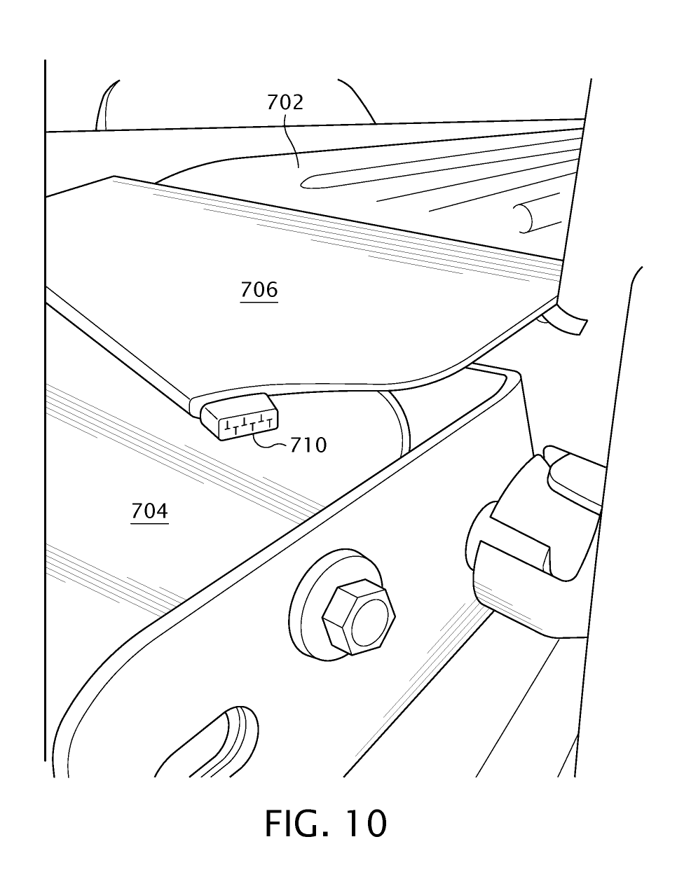

FIG. 10 shows the debris blocking device installed in a truck bed with the tail gate lowered and the removable coupling to the tail gate.

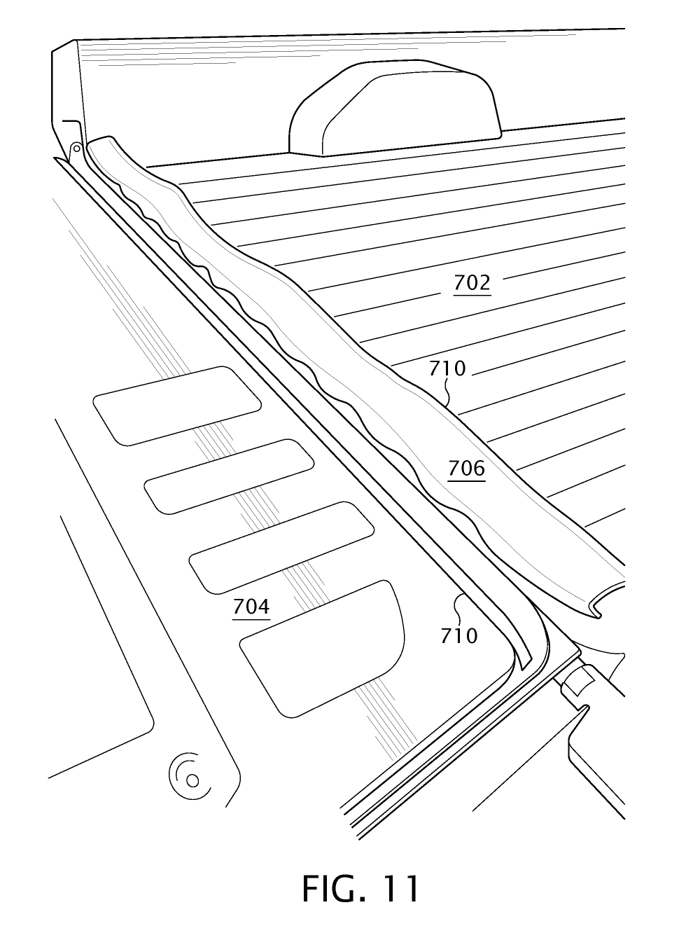

FIG. 11 the debris blocking device installed in a truck bed with the tail gate lowered and with the blocking device disengaged from its mating tape strip prior to removing the tail gate.

FIGS. 8-11 show various views of the debris blocking device installed in a pickup truck box.

It will be obvious to those skilled in the art to make various changes, alterations and modifications to the invention described herein. To the extent such changes, alterations and modifications do not depart from the spirit and scope of the appended claims; they are intended to be encompassed therein.

Those skilled in the art will realize that the process sequences described above may be equivalently performed in any order to achieve a desired result. Also, sub-processes may typically be omitted as desired without taking away from the overall functionality of the processes described above.

1. A debris blocking device comprising:
an adhesive strip
an adhesive backed fastening tape having a first side and a second side removabally coupled together; and
an elongate flap having a bottom surface having a tailgate end and a truck bed end, with the adhesive strip disposed along the tailgate end and the adhesive backed fastening tape along the tailgate end.
